(19) United States
(12) Patent Application Publication
(10) Pub. No.: US 2012/0212427 A1
(43) Pub. Date: Aug. 23, 2012

(54) DRIVING DEVICE FOR INTERACTING WITH TOUCH SCREEN PANEL ASSEMBLY AND METHOD FOR INTERACTING SAME WITH TOUCH SCREEN PANEL ASSEMBLY

(75) Inventors: An-Kuo Li, Zhubei City (TW); Chi-Hui Yeh, Zhubei City (TW)

(73) Assignee: Medici Creativity Co., Ltd., Zhubei City (TW)

(21) Appl. No.: 13/072,758

(22) Filed: Mar. 27, 2011

(30) Foreign Application Priority Data
Feb. 18, 2011 (TW) 100105469

(51) Int. Cl. G06F 3/041

(52) U.S. Cl. 345/173

(57) ABSTRACT

The invention is to provide a driving device for interacting with a touch screen panel assembly and a method for interacting the same with a touch screen panel assembly. The touch screen panel assembly has a touch screen panel and a processor. The driving device includes a body, a trigger element, a receiving element, a controlling element and a responding element. When the driving device body is placed on the touch screen panel with its bottom side facing the touch screen panel assembly, the trigger element of the driving device will be brought into contact with the touch screen panel, sending signals to the processor to drive the touch screen panel assembly to produce corresponding acousto-optic data. The receiving element of driving device in turn receives such acousto-optic data to produce corresponding reaction, for example, audio or optical data to interact with the touch screen panel assembly.

### 1. FIELD OF INVENTION

The invention relates to a driving device and an interactive method, and more particularly, to a driving device for interacting with a touch screen panel assembly and a method of interacting the same with a touch screen panel assembly.

### 2. DESCRIPTION OF PRIOR ART

Today, the I/O interface of an information or communication product, such as a smart phone or a tablet personal computer, is gradually changing from a display screen and a keyboard separately performing output and input operations to a touch screen panel capable of fulfilling both functions. Two major types of touch screen panels are resistive and capacitive touch panels according to operating mechanism. A resistive touch screen panel mainly comprises upper and lower ITO conductive layers laminated together, wherein the upper and lower electrodes are placed in an electrically connected state by being applied a pressure. A voltage change on the panel will be detected by a controller to measure out contact points for processing input. A capacitive touch screen panel uses a capacitance variation generated by an interaction between the human body's electrostatic field and an array of transparent electrodes and determines the touch coordinates from a current induced therefrom.

For easier understanding, the information or communication product mentioned above will be hereinafter generally named as a touch screen panel assembly. The touch screen panel assembly is normally configured to have audio and video playback and broadcast functions and, based on the current technology, many video games can be operated via a touch by a stylus or a user's finger on the related instructions shown on the screen by fingers. The touch screen panel assembly will respond to the touch and make audio and video changes, thence users can play games and have fun through the touch screen panel. However, those games are usually too complicated for babies and infants beyond their limit of comprehension and operation. This is a new era in pursuit of innovation how to surpass the limitations unilaterally contact the touch screen panel assembly, and produce interactive audio, visual and acousto-optic effect that can attract more attention from babies and infants or rehabilitate patients who suffer from degeneration, and provide the best interactive operation mode for entertainment.

Accordingly, the touch screen panel assembly integrated with an external driving device will accomplish better performance of the touch screen panel assembly not only unilateral audio, visual and acousto-optic effect, but also mutual interaction between the touch screen panel assembly and the driving device. For babies, infants and physical or mental disabled patients, they can easily operate the assembly and device to create better entertainment effect, further learning from playing interactive games, thence upgrade the application of touch screen panel assembly to a higher level via mutual interaction.

### SUMMARY OF INVENTION

An object of the invention is to provide a driving device with a trigger element located a specific position, for interacting with a touch screen panel assembly.

Another object of the invention is to provide a driving device for jointly delivering integrated signals with, and interacting with a touch screen panel assembly by using specific acousto-optic data as interactive signals.

A still another object of the invention is to provide a method for interacting a driving device with a touch screen panel assembly.

A yet still another object of the invention is to provide a method for interacting a driving device with a touch screen panel assembly, the driving device being provided with a trigger element located a specific position to trigger a touch screen panel assembly and, upon immediately receiving corresponding acousto-optic data from the touch screen panel assembly, the driving device starting to demonstrate the other data.

According to the first aspect of the invention, the driving device comprises a body having a bottom side, a trigger element protruding outwardly from the bottom side, a receiving element, a responding element, and a controlling element for driving the responding element upon receipt of a first signal from the receiving element. The touch screen panel assembly comprises a touch screen panel responsive to multiple touches, a built-in loudspeaker and a processor for receiving a second recognition signal from the touch screen panel upon the touch screen panel being touched and for driving the touch screen panel to display optical data or driving the loudspeaker to produce sound. The inventive method disclosed herein is useful for interacting a driving device with a touch screen panel assembly, which comprises the steps of:

a) placing the driving device on the touch screen panel with the bottom side facing the touch screen panel, so that the trigger element is brought into contact with and drives the touch screen panel;

b) allowing the processor to drive the touch screen panel to display the optical data or drive the loudspeaker to produce the sound upon the touch screen panel being driven, and then allowing the receiving element to receive the optical data displayed by the touch screen panel or the sound produced by the loudspeaker and transmits the first signal to the controlling element; and

c) allowing the controlling element to drive the responding element upon receipt of the first signal from the receiving element, so that the responding element is controlled to respond in accordance with the first signal.

According to the second aspect of the invention, the driving device as disclosed herein is useful for interacting with a touch screen panel assembly comprising a touch screen panel responsive to multiple touches, a built-in loudspeaker and a processor for receiving a recognition signal from the touch screen panel upon the touch screen panel being touched and for driving the touch screen panel to display optical data or driving the loudspeaker to produce sound. The driving device comprises a body having a bottom side, a trigger element mounted beneath the bottom side and adapted for being brought into contact with and driving the touch screen panel when the driving device is placed on the touch screen panel with the bottom side facing the touch screen panel, a receiving element for receiving the optical data displayed by the touch screen panel or the sound produced by the loudspeaker upon the processor driving the touch screen panel to display the optical data or driving the loudspeaker to produce the sound after the touch screen panel is driven, a responding element, and a controlling element for driving the responding element upon receipt of a signal from the receiving element.

The driving device for interacting with a touch screen panel assembly and the method of interacting the same with a touch screen panel assembly as disclosed herein involves rendering a touch screen panel assembly to generate acousto-optic data in response to the trigger element and meanwhile allowing the driving device to detect the acousto-optic data generated by the touch screen panel assembly and further generate corresponding audio effect or responding luminescent images. The invention realizes a mutual interaction between the touch screen panel assembly and the driving device and creates a vivid audio-visual entertainment, thereby fulfilling all purposes mentioned previously.

### BRIEF DESCRIPTION OF THE DRAWINGS

The above and other objects, features and effects of the invention will become apparent with reference to the following description of the preferred embodiments taken in conjunction with the accompanying drawings, in which:

FIG. 1 is a perspective view of the driving device according to the first preferred embodiment of the invention interacting with a touch screen panel assembly;

FIG. 2 is a circuit block diagram of the touch screen panel assembly in collocation with the driving device shown in FIG. 1;

FIG. 3 is a circuit block diagram of the driving device shown in FIG. 1;

FIG. 4 is a schematic diagram showing the bottom side of the driving device shown in FIG. 1;

FIG. 5 is a flow chart of the interacting method according to the first preferred embodiment of the invention;

FIG. 6 is a diagram showing the interaction according to the first preferred embodiment of the invention;

FIG. 7 is a perspective view of the driving device according to the second preferred embodiment of the invention interacting with a touch screen panel assembly;

FIG. 8 is a schematic diagram showing the bottom side of the driving device shown in FIG. 7;

FIG. 9 is a circuit block diagram of the touch screen panel assembly in collocation with the driving device shown in FIG. 7;

FIG. 10 is a circuit block diagram of the driving device shown in FIG. 7;

FIG. 11 is a diagram showing the interaction according to the second preferred embodiment of the invention; and

FIGS. 12 and 13 are working diagrams for the third preferred embodiment of the invention.

### DETAILED DESCRIPTION OF INVENTION

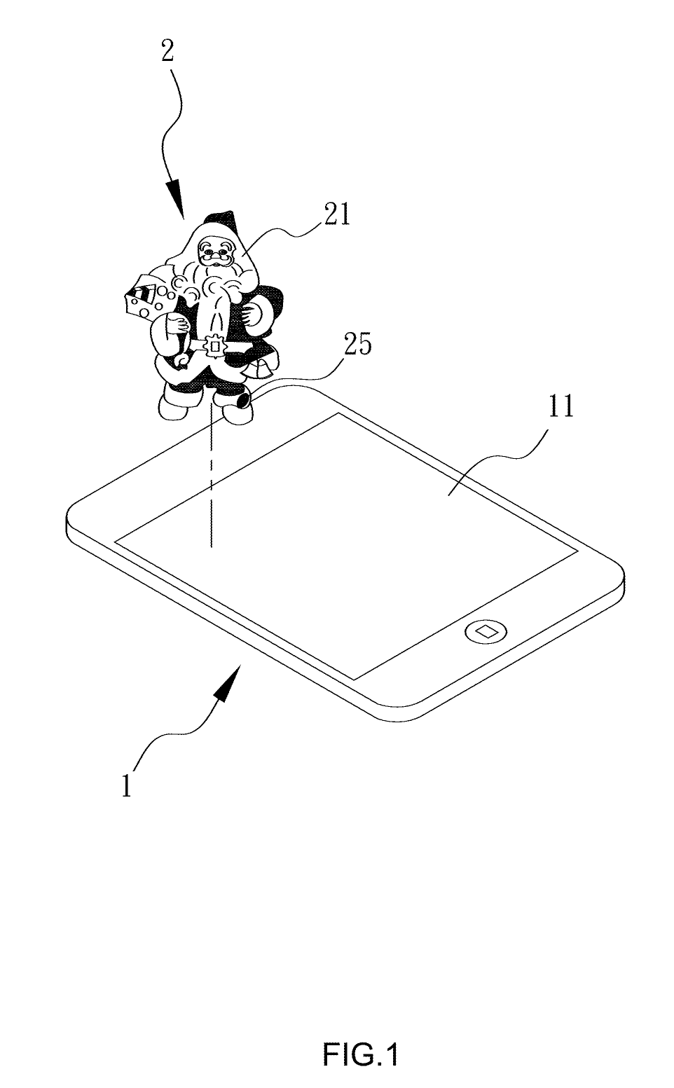

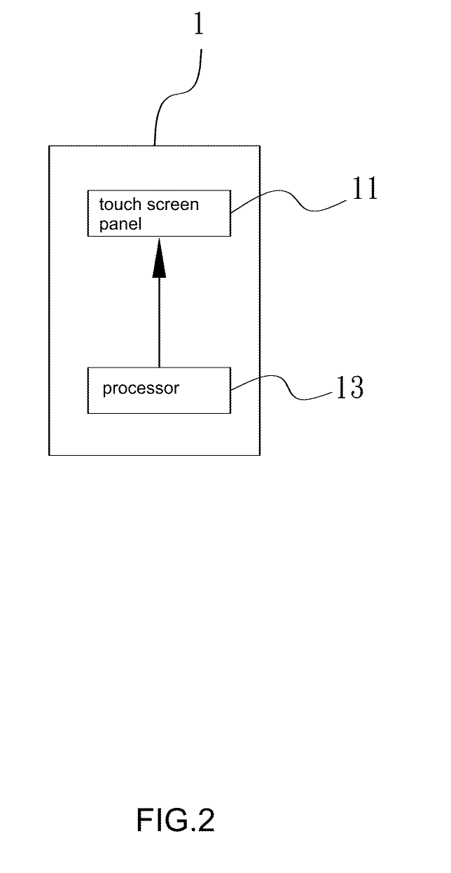

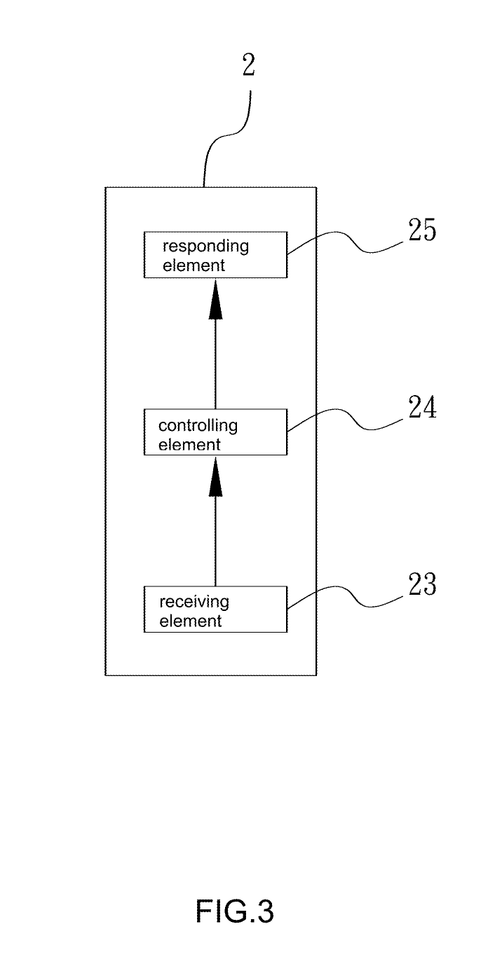

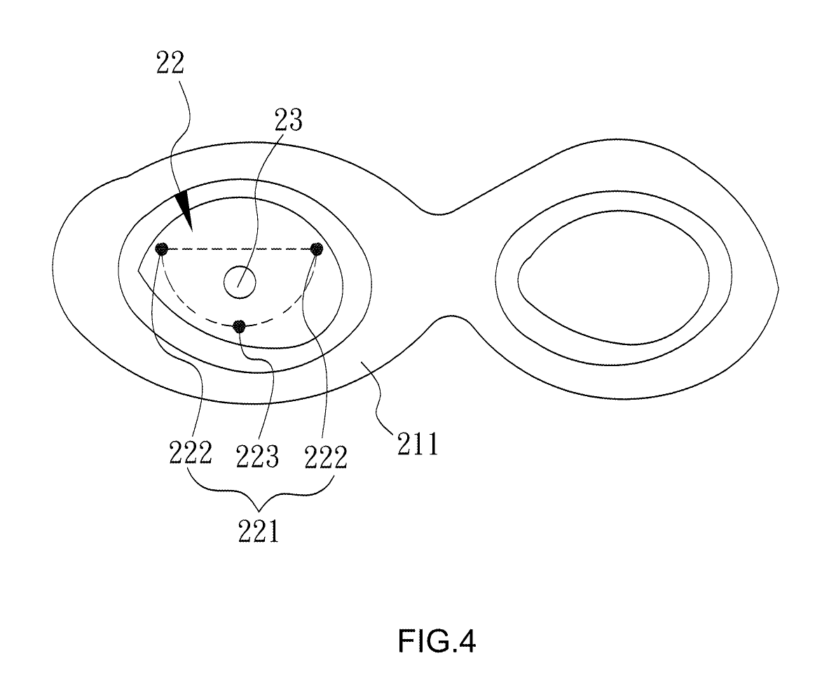

FIGS. 1 to 3 show the first preferred embodiment of the invention, interacting a driving device with a touch screen panel assembly for reference. The touch screen panel assembly 1 for the embodiment takes an iPad® for an example, including a touch screen panel 11 responsive to multiple touches. The touch screen panel assembly 1 further includes a processor 13. Please also refer to FIG. 4, a driving device 2 comprises a body 21 with a bottom side 211, a trigger element 22 mounted beneath and protruded outwardly from the bottom side 211, a receiving element 23, a controlling element 24 and a responding element 25.

For the first preferred embodiment, a trigger element 22 has a protruding portion 221 comprising three protruding points made of material with specific electric characteristics, such as metal or graphite. The receiving element 23 as illustrated is an optical pickup device mounted at the center of the bottom side 211 of the body 21. The responding element 25 as illustrated comprises a built-in motor and a sound-producing element. As shown in FIG. 4, the three protruding points according to this embodiment are positioned such that two reference points 222 among the three protruding points are regarded as two ends of the diameter of a semi-circle and the remaining protruding point is set to locate on the circumference of the semi-circle, named as a recognition point 223. When the touch screen panel 11 senses the trigger element 22, it will be searching for the location of the recognition point 223 with reference to the positions of the reference points 222, thereby identifying different types of driving devices. It is apparent to those skilled in the art that the identification can be done on the basis of the distance between the reference points or the number of multiple recognition points, in addition to based on the locations of the protruding points.

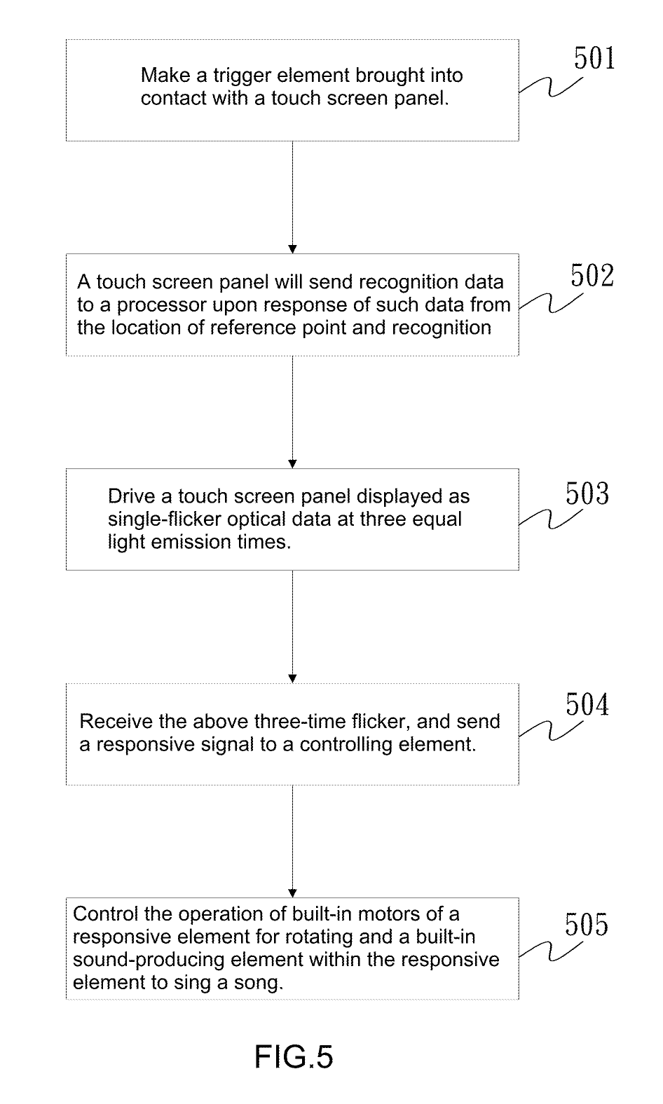

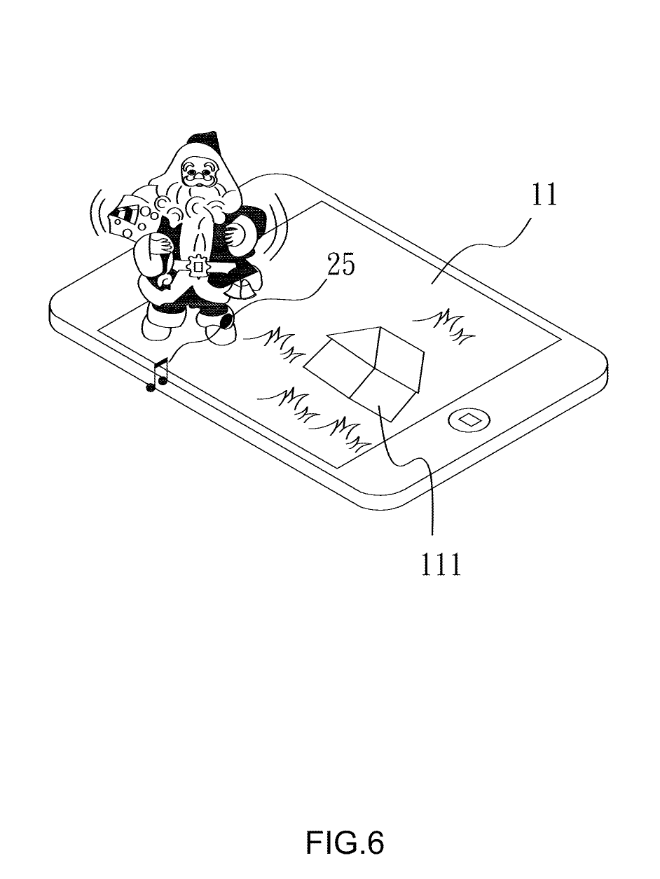

FIG. 5 shows the steps of the operation procedure of interacting method according to this embodiment. First, in step 501, a driving device 2 is placed on the touch screen panel 11 of the touch screen panel assembly 1, with the bottom side 211 of the driving device 2 facing the touch screen panel 11, thereby bringing the trigger element 22 into contact with the touch screen panel 11. The driving device 2 according to this embodiment is particularly designed for the Christmas season so that the body 21 is configured as a Santa Claus puppet. Next, in step 502, the touch screen panel 11 of the touch screen panel assembly 1 will transmit recognition data to the processor 13 upon sensing the locations of reference points 222 and recognition point 223. Upon receiving the recognition signals from the touch screen panel 11, the processor 13 searches for the corresponding driving program stored therein. In this embodiment, the driving device is corresponding to the images and song of “Santa Claus is coming to town”. As a result, in step 503, the touch screen panel 11, namely, an iPad, is driven to emit single-point optical data 111 to a region centered by the three protruding points 222, 223, as shown in FIG. 6. Preferably, the single-point optical data 111 comprise three equal periods of flash light emission.

The bottom side of the Santa Claus puppet is provided with a simple CCD (Charge Coupled Device) optical pickup device, which receives the above-mentioned three equal periods of flash light emission in step 504 and transmits a corresponding signal to the controlling element 24. After receiving the signal, the controlling element 24 compares the same with the information stored in the memory and recognizes that the iPad is going to display the corresponding video and image files. Finally, in step 505, the controlling element 24 activates the built-in motor in the responding element 25 on one hand, so that the Santa Claus puppet begins to dance. On the other hand, a built-in sound-producing element in the responding element 25 is also activated to play the song “Santa Claus is coming to town”. Thence, the Santa Claus puppet as a driving device is singing and twisting its body at the same time, collaborating with an image displayed on the iPad beneath to constitute a complete three-dimensional video-audio entertainment source.

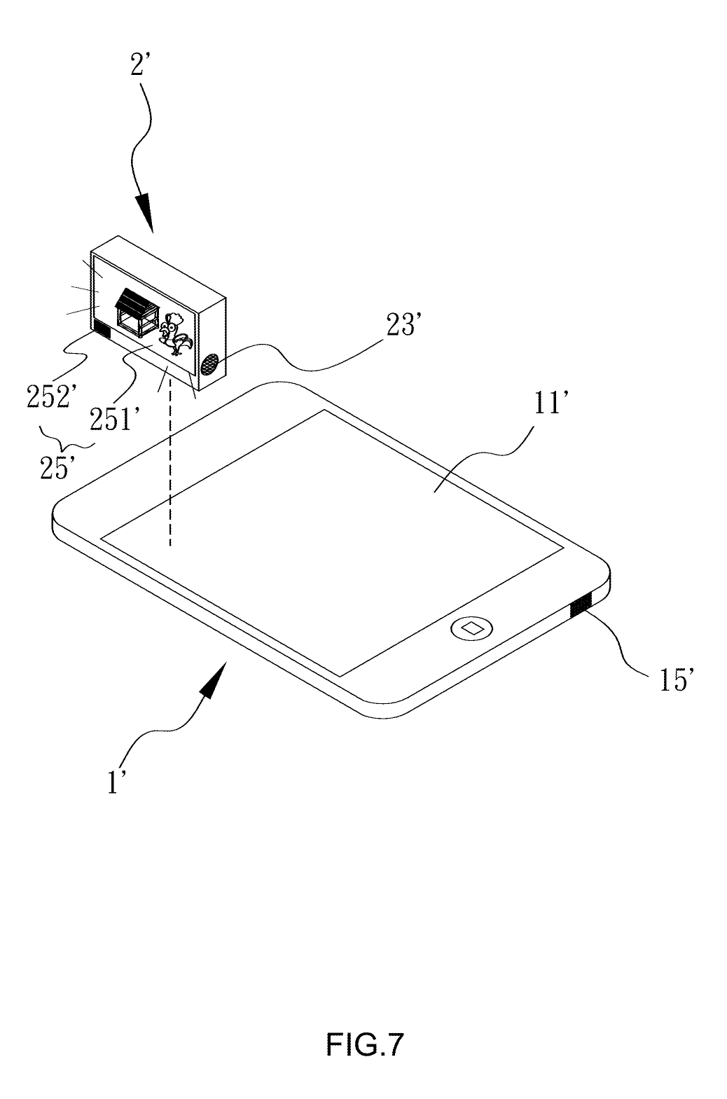

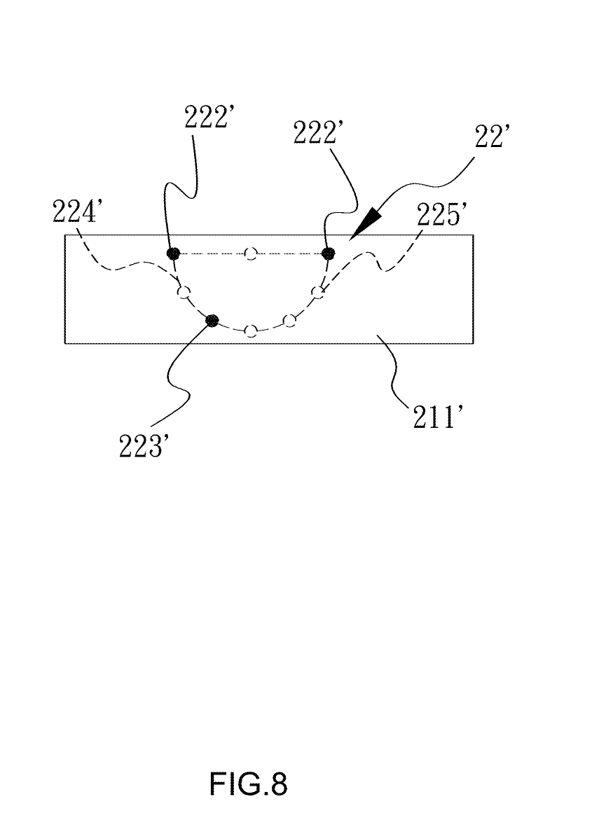

It is apparent to those skilled in the art that the embodiment described above is merely a demonstration for an easier comprehension, wherein the practical configurations of the trigger element, the receiving element and the responding element, as well as the interaction modes among them, possess sufficient flexibility. As shown in FIGS. 7 and 8, the second preferred embodiment according to the invention has a touch screen panel assembly 1′ including a loudspeaker 15′ mounted on one side. The receiving element 23′ of the driving device 2′ for this embodiment is illustrated herein as a microphone for receiving the sound produced by the loudspeaker 15′. The controlling element 24′ as illustrated herein is a simple trigger switch directly responsive to the audio signals received by the receiving element 23′. A trigger element 22′ mounted at the bottom side 211′ includes two reference points 222′ secured on the bottom side 211′ and a recognition stud 223′ adapted for being inserted into anyone of recognition apertures 225′. Upon the bottom side 211′, the distance between the two reference points 222′ constitutes a diameter of the circumference 224′. On the circumference 224′, there are several recognition apertures 225′ for receiving the recognition stud 223′.

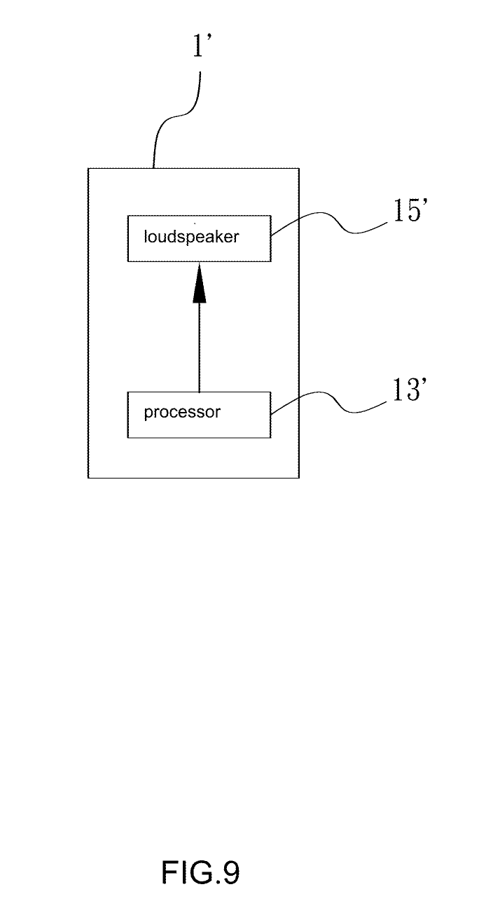

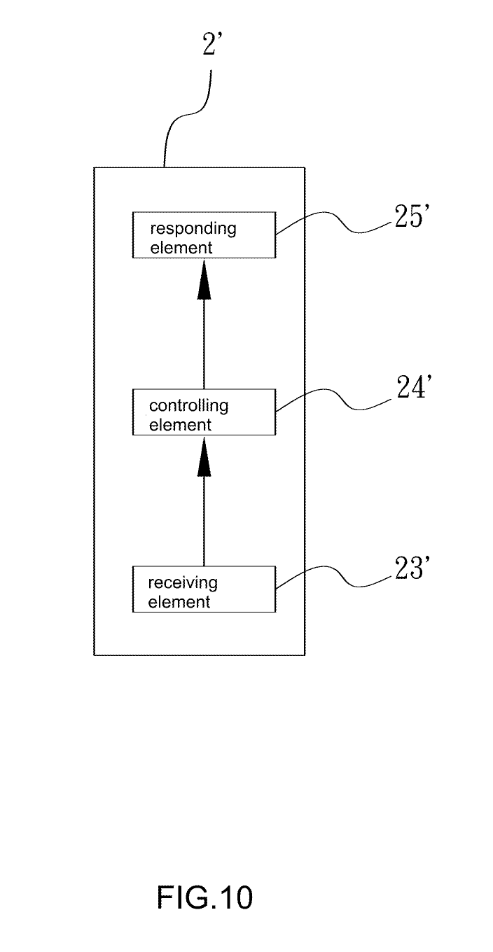

In this embodiment, the driving device 2′ is an electronic pet game device with a responding element 25′ comprising a small LCD panel 251′ as a light emitting element and a speaker 252′ as a sound-producing element. Usually, the driving device 2′ displays a virtual pet rooster's video picture that users can virtually feed and play with this pet rooster through a human-machine interface of the game device. Therefore, the pet rooster's picture will be shown on the LCD panel 251′ of the driving device 2′. Now referring to FIGS. 9, 10 and 11, the driving device 2′ is placed on the touch screen panel 11′ and the touch screen panel assembly 1′ will proceed the same procedure as described in the previous embodiment to identify the trigger element 22′. The touch screen panel assembly 1′ then transmits recognition data to the processor 13′ which in turn drives the loudspeaker 15′ to playback specific voice messages.

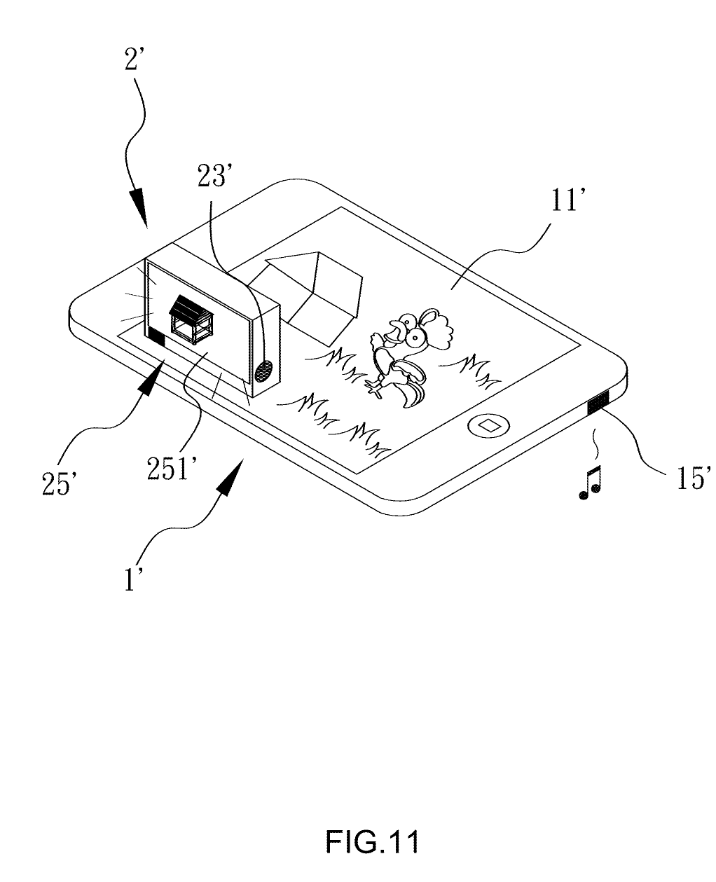

According to this embodiment, the audio content exclusively instituted for the particular location of the recognition stud 223′ is a pet rooster crying out cheering sound, for example. The cackling sound output from the touch screen panel assembly 1′ will be received by the receiving element 23′ which is illustrated as a microphone. The receiving element 23′ activates the controlling element 24′ upon receipt of the pet rooster's crying, and the controlling element 24′ in turn drives the responding element 25′ according to the crying sound from the receiving element 23′. As shown in FIG. 11, the responding element 25′, which is illustrated as an LCD panel 251′, removes the video picture of the pet rooster and shows only an empty henhouse there. On the contrary, the touch screen panel assembly 1′ will follow up the preset program to show pictures of a pet rooster and brushwood. It is represented for the user that this interaction has released the pet rooster from the pet game device, running to the touch screen panel assembly 1′ playing and looking for food. And, after a preset period of time, the touch screen panel assembly 1′ will make the pet rooster within the touch screen panel assembly 1′ disappear again, and the pet rooster shows up on the LCD panel of the driving device 2′ at the same time, implying that it automatically gets back home after having a great time. The recognition stud 223′ is available to different recognition apertures 225′ to generate recognition signals for different kinds of electronic pets. This allows multiple friends to be able to use the same pet game device, feeding several pet roosters and every user respectively feeding his/her own pet.

It is apparent to a skilled artisan that the so-called “responding” of the driving device is not limited to sound production, action or display modes. Currently, one commonly used game card comprises magnetic stripes for storing data, such as the identification of a user, and the data of a virtual dinosaur corresponding to such identification data are stored in a remote server. Two users can respectively register their game cards to a local server, and have their player's identification confirmed by a card reader of the local server. Afterward, the local server is connected to and reads the data of the virtual dinosaurs stored in the remote server, and a microprocessor identifies the combating strength of two participating virtual dinosaurs in the game. Battling pictures will be shown on the screen of the local server, and finally store the result of battle back to the remote server after deciding winner and loser.

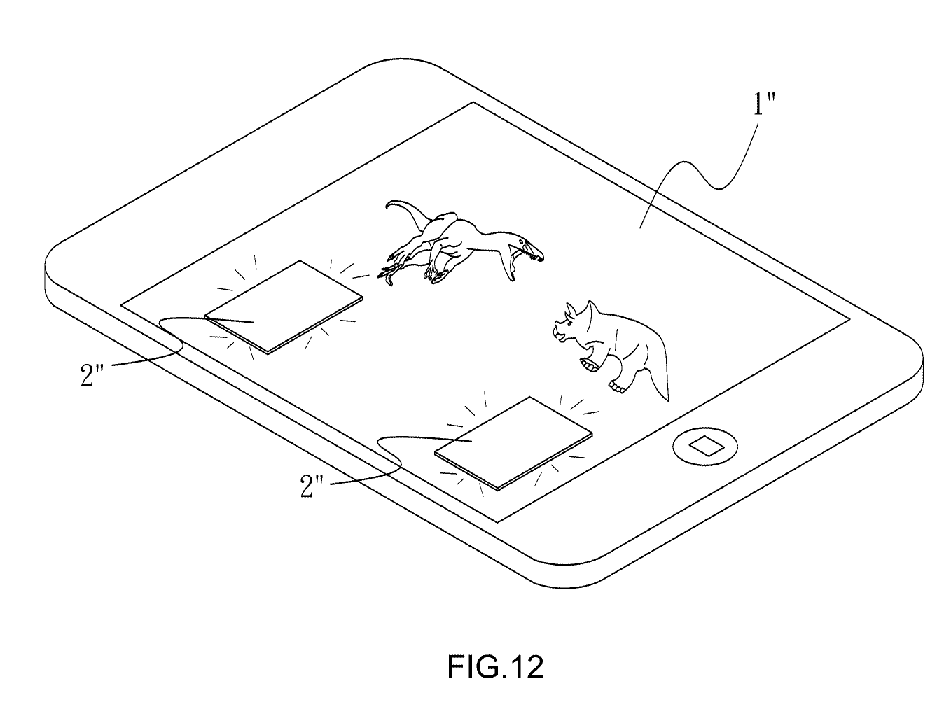

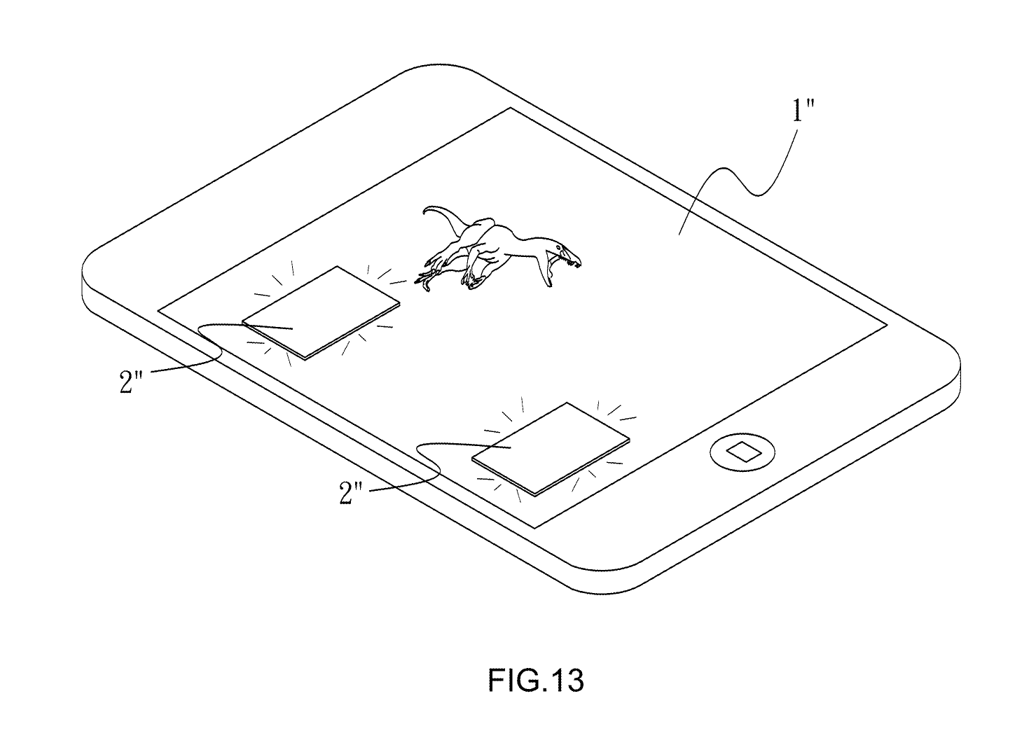

The interactive process of the game must be done by registering a card. The card and the card reader are liable to damage after registering many times that might lead to data misreading, wrong records or loss. A disclosed herein, the magnetic strip card can be replaced with a card-shaped driving device 2″ with a trigger element at its bottom side. A receiving element responsive to light is set inside the game card and a rewritable memory is employed as a responding element. As shown in FIG. 12, a user places the card driving device 2″ on a touch screen panel assembly 1″, which will be driven by a trigger element to access a remote server for data of virtual dinosaurs of both sides to play games. Finally as shown in FIG. 13, the result of the battle is on one hand output to the remote server; on the other hand, the touch screen panel assembly 1″ is emitting light signals to write data into the rewritable memory of the card driving device 2″ for backup. By this means, the responding method will decrease the risk of data damage or controversy.

The method for interacting a driving device with a touch screen panel assembly as disclosed herein is to use the driving device to interact with the touch screen panel assembly through specific acousto-optic data as interactive messages, which helps both collaborate to produce complete messages and enhance better display effect and greater fun. Therefore, for those who fail to appreciate the complicated functions of a touch screen panel assembly, such as a smart phone or a tablet personal computer, creative audio-visual entertainment and interaction can still be fully enjoyed. The invention fulfills the purposes mentioned above accordingly.

While the invention has been described with reference to the preferred embodiments above, it should be recognized that the preferred embodiments are given for the purpose of illustration only and are not intended to limit the scope of the present invention and that various modifications and changes, which will be apparent to those skilled in the relevant art, may be made without departing from the spirit and scope of the invention.

What is claimed is:

1. A method for interacting a driving device with a touch screen panel assembly, wherein the driving device comprises a body having a bottom side, a trigger element mounted beneath the bottom side, a receiving element, a responding element, and a controlling element for driving the responding element upon receipt of a first signal from the receiving element, and wherein the touch screen panel assembly comprises a touch screen panel responsive to multiple touches, a built-in loudspeaker and a processor for receiving a second recognition signal from the touch screen panel upon the touch screen panel being touched and for driving the touch screen panel to display optical data or driving the loudspeaker to produce sound, the method comprising the steps of:
a) placing the driving device on the touch screen panel with the bottom side facing the touch screen panel, so that the trigger element is brought into contact with and drives the touch screen panel;
b) allowing the processor to drive the touch screen panel to display the optical data or drive the loudspeaker to produce the sound upon the touch screen panel being driven, and then allowing the receiving element to receive the optical data displayed by the touch screen panel or the sound produced by the loudspeaker and transmits the first signal to the controlling element; and
c) allowing the controlling element to drive the responding element upon receipt of the first signal from the receiving element, so that the responding element is controlled to respond in accordance with the first signal.

2. The method according to claim 1, wherein the receiving element of the driving device is an optical pick-up member, and wherein the step b) comprises allowing the optical pick-up member to pick up at least a part of the optical data displayed by the touch screen panel and converts the at least a part of the optical data into electrical signals which are then transmitted to the controlling element.

3. The method according to claim 1, wherein the responding element comprises a sound-producing member, and wherein the step c) comprises allowing the controlling element to drive the sound-producing member to produce sound.

4. The method according to claim 1, wherein the responding element comprises a light-generating member, and wherein the step c) comprises allowing the controlling element to drive the light-generating member to generate light.

5. A driving device for interacting with a touch screen panel assembly, wherein the touch screen panel assembly comprises a touch screen panel responsive to multiple touches, a built-in loudspeaker and a processor for receiving a second recognition signal from the touch screen panel upon the touch screen panel being touched and for driving the touch screen panel to display optical data or driving the loudspeaker to produce sound, the driving device comprising:
a body having a bottom side;
a trigger element mounted beneath the bottom side and adapted for being brought into contact with and driving the touch screen panel when the driving device is placed on the touch screen panel with the bottom side facing the touch screen panel;
a receiving element for receiving the optical data displayed by the touch screen panel or the sound produced by the loudspeaker upon the processor driving the touch screen panel to display the optical data or driving the loudspeaker to produce the sound after the touch screen panel is driven;
a responding element; and
a controlling element for driving the responding element upon receipt of the first signal from the receiving element.

6. The driving device according to claim 5, wherein the trigger element comprises a plurality of protruding portions having specific electrical characteristics.

7. The driving device according to claim 6, wherein the protruding portions include at least two reference points and at least one recognition point located on a circumference of a circle having a diameter equal to a distance between the two reference points with the circumference of the circle passing through the two reference points.

8. The driving device according to claim 5, wherein the receiving element is an optical pick-up member for picking up at least a part of the optical data displayed by the touch screen panel and converting the at least a part of the optical data into electrical signals which are then transmitted to the controlling element.

9. The driving device according to claim 5, wherein the responding element comprises a sound-producing member.

10. The driving device according to claim 5, wherein the responding element comprises a light-generating member.
